(19) United States
(12) Patent Application Publication
(10) Pub. No.: US 2012/0176608 A1
(43) Pub. Date: Jul. 12, 2012

(54) SYSTEM AND METHOD FOR ANTENNA ALIGNMENT

(76) Inventor: James Charles McCown, Erda, UT (US)

(21) Appl. No.: 13/345,697

(22) Filed: Jan. 7, 2012

Related U.S. Application Data
(60) Provisional application No. 61/430,824, filed on Jan. 7, 2011.

(51) Int. Cl. G01B 11/26; H01Q 1/42

(52) U.S. Cl. 356/138; 343/872

(57) ABSTRACT

According to various embodiments, a parabolic antenna may include a radome with an optically transparent window. The parabolic antenna may include a feedhorn socket configured to receive a feedhorn assembly. The feedhorn socket may also be configured to receive a spotting scope. According to various embodiments, the spotting scope may be mounted in place of the feedhorn assembly and used to optically align the parabolic antenna with respect to a distant target. The optically transparent window positioned in the radome may allow a user to see through the radome. Once aligned, the spotting scope may be removed from the feedhorn socket. A feedhorn assembly may then be secured in the feedhorn socket and a radio unit coupled thereto for radio frequency transmission.

### CROSS-REFERENCE TO RELATED APPLICATIONS

This U.S. nonprovisional patent application claims benefit and priority under 35 U.S.C. §119(e) of the filing of U.S. provisional patent application No. 61/430,824 filed on Jan. 7, 2011, titled “SYSTEM AND METHOD FOR ANTENNA ALIGNMENT”, the contents of which are expressly incorporated herein by reference for all purposes as if fully set forth herein.

### BACKGROUND OF THE INVENTION

1. Field of the Invention

This disclosure generally relates to antennas for wireless communication systems. More particularly, this disclosure describes systems and methods for visually aligning an antenna using a spotting scope selectively mounted in place of a feedhorn assembly.

2. Description of Related Art

Wireless radio links are commonly used to transmit data from one location to another, e.g., from one building to another building in a computer network or data link. This wireless transmission of data is frequently bidirectional. Such radio links utilize electromagnetic radiation, i.e., radio waves, of a specified frequency and data-encoding scheme. An antenna is used to transmit the electromagnetic radiation from a first location to a second location where it is received by a second antenna and decoded for use at the second location. Typically, there is a line-of-sight path between the radio link antennas, so that radio wave propagation is free from obstructions.

An antenna may not radiate in the same way in all directions. Rather it has radiation characteristics that may be represented by a radiation pattern that describes the correlation between, e.g., the field strength radiated by the antenna and the direction in which it is transmitted. One class of antennas are designed to radiate strongly in one direction only, whereby the radiation pattern of such an antenna typically has one main lobe and weaker side lobes. The radiation pattern is an important factor in antenna design. Radio link antennas used to transmit data over large distances, e.g., between buildings, are highly directional, i.e., the main lobe of its radiation pattern is narrow in both the vertical and horizontal directions. In fact, it is advantageous for that an antenna be highly directional so that it causes fewer disturbances to other antennas.

Thus, such highly directional antennas must be aimed at another receiving antenna in a very careful and precise manner. The direction of the main lobe of an antenna is also dependent on the construction of the antenna and how its structure may be mounted and adjusted to aim the antenna at its target, i.e., another transmitting or receiving antenna.

One conventional approach to aiming radio link antennas involves the use of a so-called automatic gain control (AGC) voltmeter to measure the transmitting field strength at a receiving antenna. This approach requires simultaneous adjustment of the direction of the actively transmitting antenna and monitoring of the field strength at the receiving antenna to obtain maximum field strength, both vertically and horizontally. Of course, there are drawbacks with this approach. First, the transmitting antenna must be radiating (power switched on) which may cause a hazardous situation (electrical power and electromagnetic radiation) for the person(s) making the adjustments to the aiming of the transmitting antenna and for the person(s) at the receiving antenna. Second, it is possible to erroneously lock onto a strong side lobe, or have to deal with signal reflections from the surroundings which may affect the measured field strength, distorting measurement results and causing aiming errors. Third, using such an aiming approach requires two installation teams, each placed in one end of the radio link for measuring and aiming the respective antennas. Fourth, if both antennas are highly directional (the normal case), considerable time can be expended in searching for the other signal as at least one of the two antennas must be aligned to the correct path within a few degrees before any signal is detected from either end.

Optical scopes have also been proposed for aiming a radio link antenna, see, e.g., U.S. Pat. No. 6,538,613 to Pursiheimo. However, the arrangement described by Pursiheimo relies on a line of sight based on where the scope is mounted rather than the actual placement of the feedhorn assembly. For this reason, there is opportunity for alignment error depending on how well the optical scope line of sight correlates with the actual direction of the main lobe of the transmitting antenna. In view of the shortcomings of the prior art, there exists a need in the art for an improved system and method for antenna alignment.

### BRIEF SUMMARY OF THE INVENTION

A method for visually aligning a parabolic antenna is disclosed. The method may include mounting a spotting scope in a feedhorn socket of a parabolic antenna. The method may further include utilizing the spotting scope to optically align the parabolic antenna with respect to a distant target. The method may further include removing the spotting scope from the feedhorn socket of the parabolic antenna.

Another embodiment of a parabolic antenna for radio frequency communications is disclosed. The parabolic antenna may include a parabolic dish. The parabolic antenna may further include a feedhorn socket coupled to the parabolic dish. The parabolic antenna may further include a radome coupled to the parabolic dish, the radome including an optically transparent window. The parabolic antenna may further include the feedhorn socket configured to selectively receive a spotting scope, such that the spotting scope is coaxially secured with respect to the optically transparent window in the radome. The parabolic antenna may further include the feedhorn socket further configured to selectively receive a feedhorn assembly.

Another embodiment of a parabolic antenna for radio frequency communications is disclosed. According to this embodiment, the parabolic antenna may include a parabolic dish including a feedhorn socket adapted for receiving a feedhorn assembly. The parabolic antenna may further include a radome adapted for selective coupling to the parabolic dish and covering the feedhorn assembly. The parabolic antenna may further include rotating hardware mechanically coupled to the parabolic dish and configured for attachment to support structure. The rotating hardware may further be adapted for selectively rotating the parabolic antenna in a horizontal plane relative to the support structure. The rotating hardware may further be adapted for selectively pivoting the parabolic antenna in a vertical plane relative to the support structure. Finally, the rotating hardware may further be adapted for locking the parabolic antenna in a selected position.

An embodiment of a method for visually aligning a parabolic antenna is disclosed. The method may include providing a parabolic antenna, including a feedhorn assembly. The parabolic antenna may further include a parabolic dish having a feedhorn socket adapted for receiving the feedhorn assembly. The parabolic antenna may further include a radome adapted for selective coupling to the parabolic dish and covering the feedhorn assembly. The parabolic antenna may further include rotating hardware mechanically coupled to the parabolic dish and configured for attachment to support structure. The rotating hardware may of course be adapted for selectively rotating the parabolic antenna in a horizontal plane relative to the support structure. The rotating hardware may further be adapted for selectively pivoting the parabolic antenna in a vertical plane relative to the support structure. The rotating hardware may further be adapted for locking the parabolic antenna in a selected position. The parabolic antenna may further include a spotting scope adapted to fit within the feedhorn socket and having optical indicia for aiming at a target. The method for visually aligning a parabolic antenna may further include mounting the spotting scope within the feedhorn socket of the parabolic antenna. The method may further include optically aligning the parabolic antenna with respect to a distant target using the spotting scope. The method may further include removing the spotting scope from the feedhorn socket of the parabolic antenna. The method may further include mounting the feedhorn assembly within the feedhorn socket of the parabolic antenna.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates an optically transparent window in a radome of a parabolic antenna, according to one exemplary embodiment.

FIG. 2 illustrates a parabolic antenna with the radome removed and a feedhorn assembly mounted in a feedhorn socket, according to one exemplary embodiment.

FIG. 3 illustrates a parabolic antenna including a radome and a spotting scope mounted in place of a feedhorn assembly, according to one exemplary embodiment.

FIG. 4A illustrates an exemplary parabolic antenna with a spotting scope mounted in place of a feedhorn assembly, according to the invention.

FIG. 4B illustrates the exemplary parabolic antenna of FIG. 4A with the spotting scope removed and a feedhorn assembly mounted in its place, according to the invention.

FIG. 5 shows an exemplary parabolic antenna configured to interchangeably receive a spotting scope or a feedhorn assembly, according to the invention.

FIG. 6 shows a parabolic antenna with a feedhorn assembly mounted in a feedhorn socket prior to having a radio outdoor unit coupled thereto, according to various exemplary embodiments of the invention.

FIG. 7 provides a flow chart of an exemplary method for visually aligning a parabolic antenna utilizing a spotting scope, according to the invention.

FIG. 8 illustrates how a parabolic antenna including a radome with an optically transparent window may be aligned using a spotting scope mounted in a feedhorn socket, according to various exemplary embodiments of the invention.

FIG. 9A illustrates a parabolic antenna including a radome with an optically transparent window being aligned to a distant target using a spotting scope mounted in a feedhorn socket, according to various exemplary embodiments of the invention.

FIG. 9B illustrates the parabolic antenna after it has been aligned, the spotting scope removed, and a feedhorn assembly mounted in the feedhorn socket, according to various exemplary embodiments of the invention.

FIG. 9C illustrates the parabolic antenna receiving and/or transmitting radio signals after it has been aligned, the spotting scope removed, the feedhorn assembly mounted in the feedhorn socket, and an outdoor radio unit coupled to the feedhorn assembly, according to various exemplary embodiments of the invention.

In the following detailed description, numerous specific details are provided for a thorough understanding of the various embodiments disclosed herein. The systems and methods disclosed herein can be practiced without one or more of the specific details, or with other methods, components, materials, etc. In addition, in some cases, well-known structures, materials, or operations may not be shown or described in detail in order to avoid obscuring aspects of the disclosure. Furthermore, the described features, structures, or characteristics may be combined in any suitable manner in one or more alternative embodiments according to the spirit and scope of the present invention.

### DETAILED DESCRIPTION OF THE INVENTION

The present disclosure provides various systems and methods for visually aligning an antenna using a spotting scope mounted in a feedhorn socket in place of a feedhorn assembly. According to various embodiments, a parabolic antenna may be configured to transmit and/or receive radio signals in order to provide wireless communication between two points. According to various embodiments, an antenna may include a parabolic dish, a radome, a feedhorn assembly, and an outdoor radio unit or transmission line consisting of a coaxial cable or waveguide. According to various embodiments, the feedhorn assembly may be selectively removed and replaced with a spotting scope during alignment. Accordingly, a user may visually align the parabolic antenna by looking through the spotting scope mounted in the feedhorn socket.

It will be understood that the term “spotting scope”, as used herein, is synonymous with the terms “telescopic sight” or “riflescope”, and refers generally to a telescopic sight that has optical indicia, e.g., cross-hairs, suitable for aiming at a target. The particular manufacturer, brand, or model of spotting scope is not limiting to the inventive concepts for aiming a parabolic antenna as described herein. The term “radio unit” as used herein refers to a source of radio frequency (RF) energy that may or may not include modulated or encoded date used for radio link communications.

The terms “outdoor radio unit” and “radio outdoor unit” and the acronym ODU (outdoor unit) are all synonymous for a radio unit located adjacent to the antenna. Whereas, the term “radio unit” is more general and may include radio equipment located some distance from the antenna and employs a waveguide or coaxial (coax) cable to convey the RF signal to the antenna, and is inclusive of the outdoor radio unit embodiments. It will be understood that the type of radio unit employed does not limit embodiments of the inventive method and system for antenna alignment described herein. In other words, the invention may be applied to all types of radio units that require aiming of an antenna. However, in order to focus the discussion on the inventive concepts disclosed herein and to avoid discussion of all the possible applications of those concepts, the drawings and discussion herein are applied to embodiments that employ an outdoor radio unit.

According to various embodiments, the radome includes an optically transparent window positioned coaxially with the mounted spotting scope. Accordingly, a user is able to see through the radome while using the spotting scope to align the antenna. According to various embodiments, the size and dimensions of the optically transparent window may be dependent on the positioning, dimensions, magnification power, focal length, and/or other characteristics of the spotting scope.

According to various embodiments, the parabolic antenna may be mounted or secured using any of a wide variety of methods known in the art. For example, the parabolic antenna may be mast-mounted and include hardware allowing the parabolic antenna to rotate and/or pivot in the horizontal and vertical planes. Accordingly, a user may align the parabolic antenna with respect to a distant target by looking through the spotting scope and rotating and/or pivoting the parabolic antenna with respect to the mast. Note that this alignment may be performed without powering the antenna and without a person(s) at the distant point of reception.

According to various embodiments, a feedhorn socket may be configured to interchangeably receive a spotting scope or a feedhorn assembly. During alignment, a spotting scope may be mounted within the feedhorn socket in the same location where the feedhorn assembly is ordinarily mounted for use of the antenna during linked communications. After alignment, the spotting scope may be removed and the feedhorn assembly mounted in place within the feedhorn socket. A radio unit, such as a radio outdoor unit, may be coupled to the feedhorn assembly in order to transmit and/or receive radio signals. Methods and structure for coupling of a radio outdoor unit to a feedhorn assembly are known to those of ordinary skill in the art and, therefore, will not be further elaborated herein.

According to various embodiments, the diameter of the objective lens, overall magnification, and/or other characteristics of the spotting scope may be adapted for a specific application. For example, a spotting scope adapted to align an antenna with respect to a target 1 kilometer away may not require the same magnification as a spotting scope adapted to align an antenna with respect to a target 50 kilometers away. Additionally, according to one embodiment, a relatively high magnification spotting scope may include one or more coaxial finder scopes having a lower magnification. According to such an embodiment, a user may utilize spotting scopes of increasing magnification to incrementally align a parabolic antenna. According to yet another embodiment, multiple spotting scopes of various magnifications may be supplied to incrementally align the radio link antenna by starting with the lowest power spotting scope and sequentially removing and replacing it with the next higher magnification spotting scope until the most powerful spotting scope has been used to align the radio link antenna. According to still another embodiment, a single spotting scope having variable magnification may be used to align the radio link antenna by starting at the lowest magnification and gradually increasing magnification until the radio link antenna has been aligned with sufficient accuracy.

According to one alternative embodiment, a traditional radome (without an optically transparent window) may be utilized, in which case the radome may be removed during the alignment procedure. Moreover, one of skill in the art will recognize that the presently described systems and methods for antenna alignment utilizing a spotting scope mounted in place of a feedhorn assembly may be adapted for use with a wide variety of antennas in addition to the parabolic antennas described and illustrated herein.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, an “embodiment” may be a system, a method, or a product of a process.

It will be understood that any of a wide variety of materials and manufacturing methods may be used to produce the various components of the presently described electrical, mechanical, and/or optical components disclosed herein. Such materials and manufacturing methods are within the knowledge of one of ordinary skill in the art and, therefore, will not be further elaborated herein.

The phrases “connected to,” “networked,” “coupled to,” and “in communication with” may refer to any form of interaction between two or more entities, including mechanical, electrical, magnetic, and electromagnetic interactions as may be recognized as contextually appropriate by one of skill in the art. Additionally, two components may be connected to each other even though they are not in direct physical contact with each other and even though there may be intermediary devices between the two components.

Some of the infrastructure that can be used with embodiments disclosed herein is already available or may be adapted for a particular application, such as: general-purpose computers; computer programming tools and techniques; digital storage media; network and communication protocols, radio units, antenna dishes, radomes, feedhorns, necessary power infrastructure, and the like.

In the following description, numerous details are provided to give a thorough understanding of various embodiments; however, the embodiments disclosed herein can be practiced without one or more of the specific details, or with other methods, components, materials, etc. In other instances, well-known structures, materials, or operations are not shown or described in detail to avoid obscuring aspects of this disclosure.

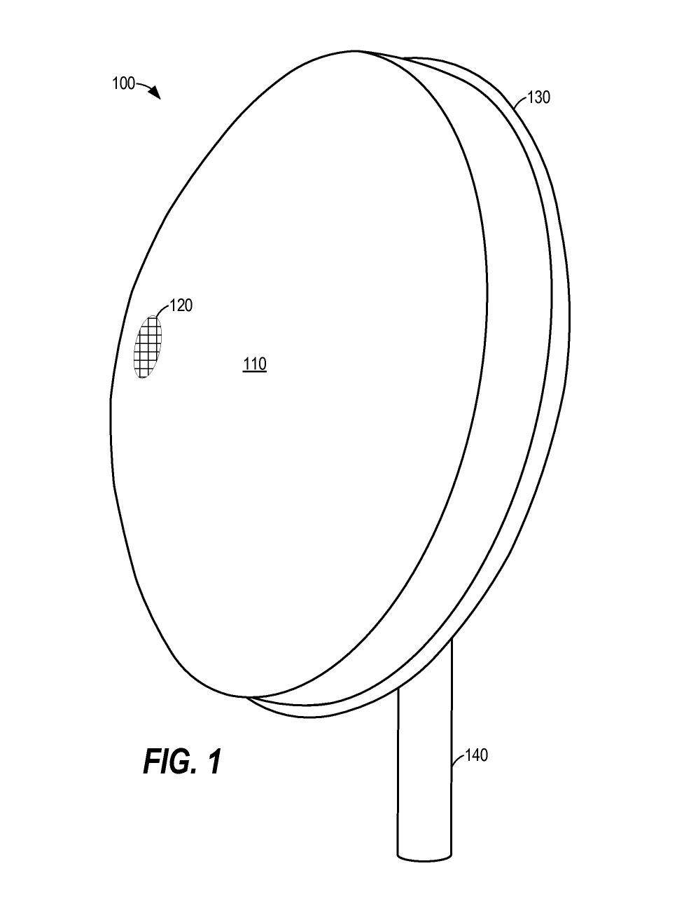

FIG. 1 illustrates an exemplary optically transparent window 120 in a radome 110 of a parabolic antenna 100. As illustrated, the radome 110 is coupled to a parabolic dish 130 and a mast 140 supports the parabolic antenna 100. According to various embodiments, the specific dimensions (both absolute and relative) of the parabolic dish 130, the radome 110, and the optically transparent window 120 may be adapted for a particular application. According to alternative embodiments, the parabolic antenna 100 may be supported by any of a wide variety of known mounting apparatuses and methods in conjunction with, or in place of, mast 140. Mast 140 may in turn be mounted into the ground or attached to some other structure, e.g., a radio tower or building.

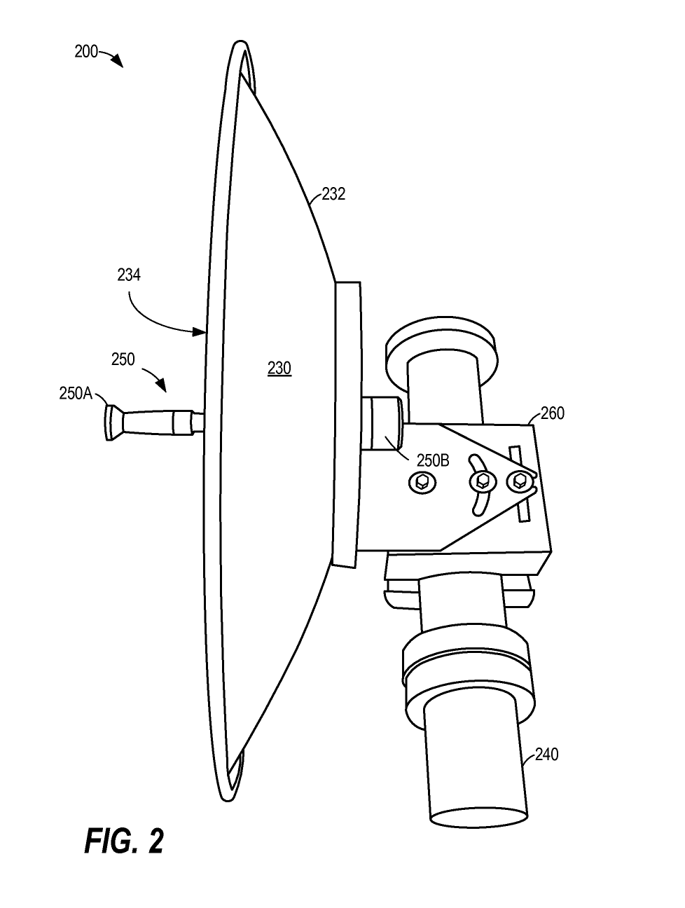

FIG. 2 illustrates an exemplary side view of a parabolic antenna 200 without a radome 110 (FIG. 1) in place. As illustrated, parabolic dish 230 may include a feedhorn socket (not visible in FIG. 2) within which a feedhorn assembly (shown generally at arrow 250) may be mounted. As illustrated the front portion 250A of the feedhorn assembly 250 may extend from the concave side (shown generally at arrow 234) of parabolic dish 230. The rear portion 250B of the feedhorn assembly 250 may mount within a feedhorn socket (not visible in FIG. 2) and extend from the convex side 232 of the parabolic dish 230. Additionally, as illustrated the parabolic antenna may be mast-mounted via rotating hardware 260 to a mast 240.

According to various embodiments, rotating hardware 260 may be configured to allow parabolic antenna 200 to rotate and/or pivot in the vertical and/or horizontal planes with respect to mast 240. Accordingly, parabolic antenna 200 may be aligned with respect to a distant target by adjusting rotating hardware 260. According to various alternative embodiments, parabolic antenna 200 may be secured in an alternative manner. For example, instead of rotating hardware 260, ball-mounts, pivot arms, levers, rotatable apparatuses, and/or similar systems and components may be utilized to selectively align and subsequently secure parabolic antenna 200 with respect to a distant target. Such alternative hardware for mounting antennas and adjusting their alignment to aim a radio link antenna are well known to one of ordinary skill in the art and, therefore, will not be further elaborated herein.

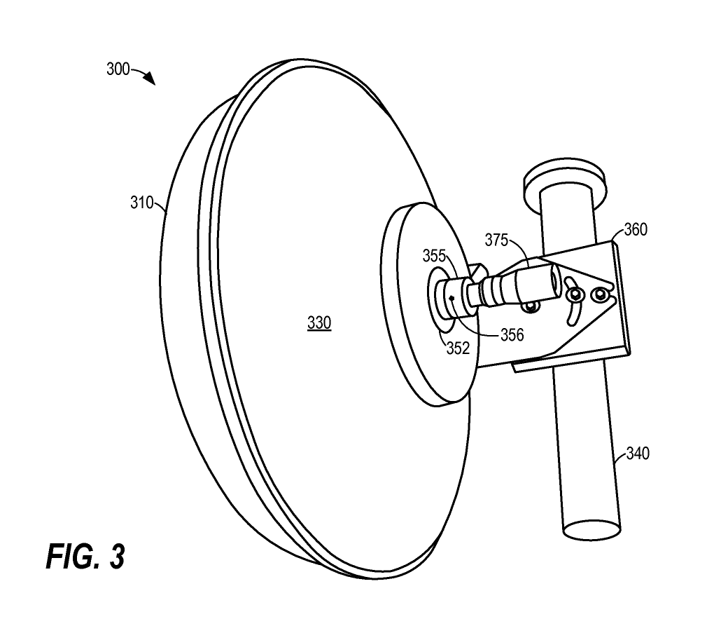

FIG. 3 illustrates an exemplary parabolic antenna 300 including a radome 310, a parabolic dish 330, and a spotting scope 375 mounted via mounting portion 355 into a feedhorn socket 352. Spotting scope 375 may be held in place by a set screw 356, by snapping in place (not shown for clarity), threaded engagement (not shown for clarity) or any other suitable means know to those of ordinary skill the art. It will be understood that any suitable telescopic sight commercially available may be employed as the “spotting scope” described herein. For example, and not by way of limitation, According to various embodiments, radome 310 may include an optically transparent window (not illustrated in FIG. 3, but see 120 FIG. 1) coaxially aligned with spotting scope 375. Additionally, parabolic antenna 300 may be selectively aligned and secured with respect to a distant target via rotating hardware 360 in conjunction with mast 340. Mounting portion 355 may be adapted to receive spotting scope 375 by various means including friction fit, set screws (not shown), rotational engagement via threaded fitment (also not shown), clamps (not shown) or any other suitable means for holding the spotting scope 375 within mounting portion 355, according to various embodiments. Mounting portion 355 may further be adapted to be received within feedhorn socket 352 by any suitable means, e.g., friction fit (not shown), set screws (not shown), rotational engagement via threaded fitment (also not shown), clamps (not shown) or any other suitable means for holding the mounting portion 355 within the feedhorn socket 352, according to various embodiments. Furthermore, mounting portion 355 may be adapted to fit any size and magnification of spotting scope 375, and may also be a kit of mounting portions (not shown) having various apertures for receiving various sizes of spotting scopes 375, according to various embodiments of the invention.

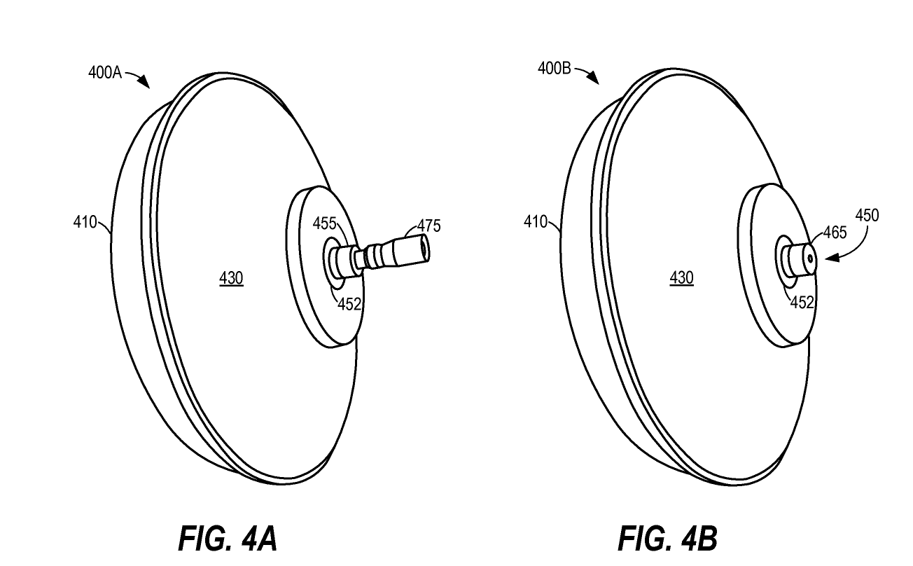

FIGS. 4A and 4B illustrate exemplary parabolic antennas 400A and 400B, each including radome 410, parabolic dish 430, and feedhorn socket 452. FIG. 4A illustrates a parabolic antenna 400A including a spotting scope 475 mounted within feedhorn socket 452 via mounting portion 455. The configuration of parabolic antenna 400A shown in FIG. 4A illustrates one embodiment of the invention suitable for optically aiming the parabolic antenna 400A by use of the spotting scope 475. In contrast, FIG. 4B illustrates a rear portion 465 of a feedhorn assembly (shown generally at arrow 450, but, substantially hidden within parabolic antenna 400B) mounted within feedhorn socket 452. Thus, the configuration of parabolic antenna 400B shown in FIG. 4B illustrates one embodiment of the invention suitable for use with a radio outdoor unit coupled to the rear portion of the feedhorn assembly (shown generally at arrow 450, but, substantially hidden within parabolic antenna 400B). From FIGS. 4A and 4B it should be evident that both the feedhorn assembly (rear portion 465 shown in FIG. 4B) and the spotting scope 475 (FIG. 4A) may be adapted for mounting in feedhorn socket 452, depending on whether the antenna 400A and 400B is being aimed or configured for radio link communications.

According to various embodiments of the present invention, parabolic antenna 400B (FIG. 4B) may be configured to receive a wide variety of feedhorn assemblies 450, each of which may be configured with different electrical and radio properties. For example, feedhorn socket 452 of parabolic antenna 400B may be configured to interchangeably receive a variety of feedhorn assemblies 450, including those tuned for a specific bandwidth, multiple bands, specific beam widths, with or without waveguides, having various polarizations, and/or other adaptations.

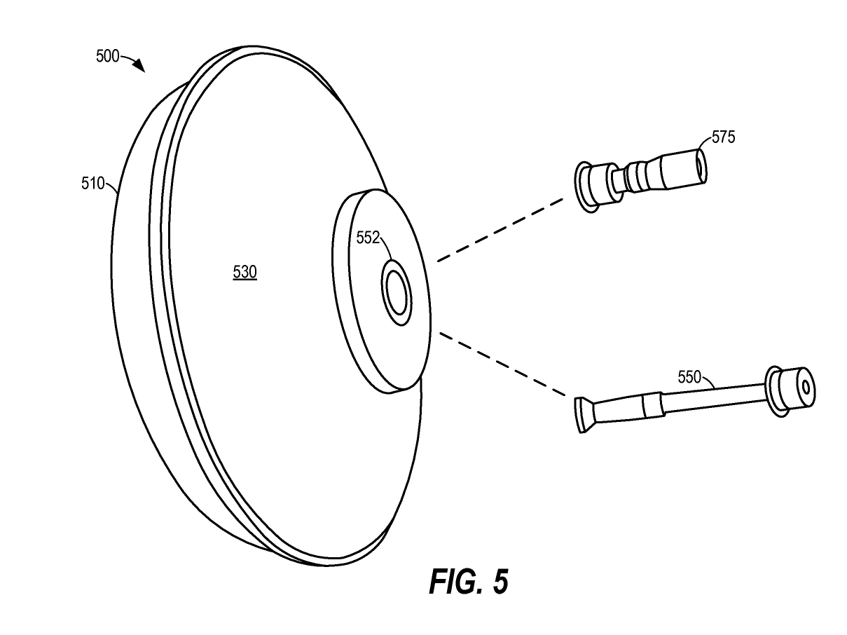

FIG. 5 illustrates an exemplary parabolic antenna 500 configured to interchangeably receive a spotting scope 575 or a feedhorn assembly 550 via feedhorn socket 552. Radome 510 may include an optically transparent window (not illustrated in FIG. 5, but see 120 FIG. 1) configured to allow a user to see through radome 510 when looking through spotting scope 575. Spotting scope 575 and similar spotting scopes illustrated throughout the drawings are merely exemplary illustrations of spotting scopes. Alternative spotting scopes may include a wide variety of shapes, magnifications and sizes and may extend within the concave portion of parabolic dish 530, or remain substantially outside of parabolic dish 530. According to various embodiments of the invention, spotting scope 575 may be of any length, optical configuration, and/or diameter.

Moreover, feedhorn assembly 550 and similar feedhorn assemblies illustrated throughout the drawings are merely exemplary illustrations of feedhorn assemblies. Alternative feedhorn assemblies may be of any shape and/or size and/or power configuration. Feedhorn assemblies may include additional components, such as built in attenuators and/or amplifiers, protection circuitry, waveguides, and/or other components related to feedhorn assemblies in general. Furthermore, feedhorn assembly 550 and/or spotting scope 575 may comprise separable components coupled together during use, according to still further embodiments.

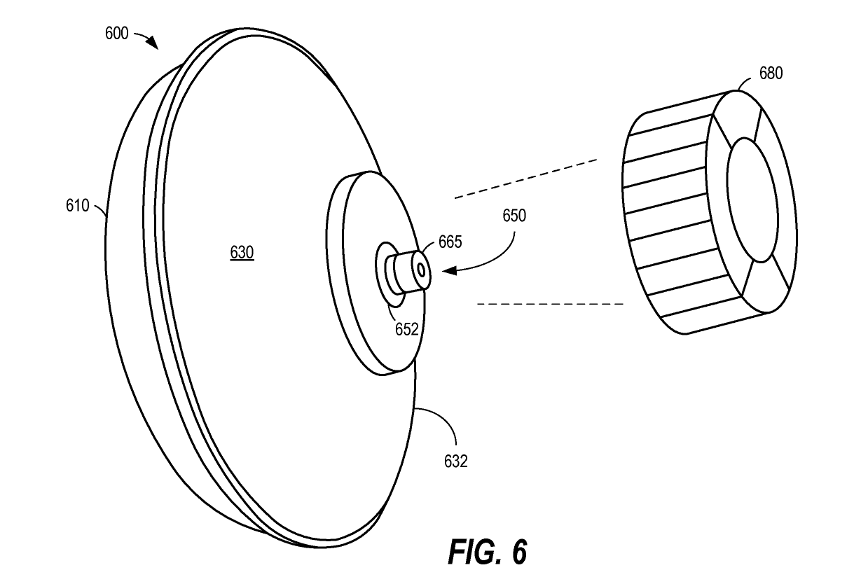

FIG. 6 illustrates another exemplary parabolic antenna 600 including a radome 610, a parabolic dish 630, and a rear portion 665 of a feedhorn assembly (shown generally at arrow 650, but, substantially hidden within parabolic antenna 600) mounted within a feedhorn socket 652. As illustrated, an outdoor radio unit (or ODU) 685 may be positioned near the convex side 632 of parabolic dish 630 and coupled electrically and/or mechanically to the rear portion 665 of the feedhorn assembly 650. Any of a wide variety of ODUs 685 known in the art may be employed with parabolic antenna 600, according to various embodiments of the present invention. According to various other embodiments, the dimensions, shapes, connection members, and other components of parabolic antenna 600 may be adapted to accommodate a specific feedhorn assembly and radio combination.

According to various embodiments, one or more components illustrated and/or described as separate components may be manufactured as a single component. For example, radome 610 and parabolic dish 630 may be manufactured as a single piece or as two separate components configured to be selectively or permanently joined post-manufacturing, according to various embodiments of the present invention. As another example, outdoor radio unit 685 and feedhorn assembly 665 may be manufactured as a single component and mounted in place after parabolic antenna 600 has been aligned using a spotting scope (not shown in FIG. 6, but see, e.g., spotting scope 575 in FIG. 5).

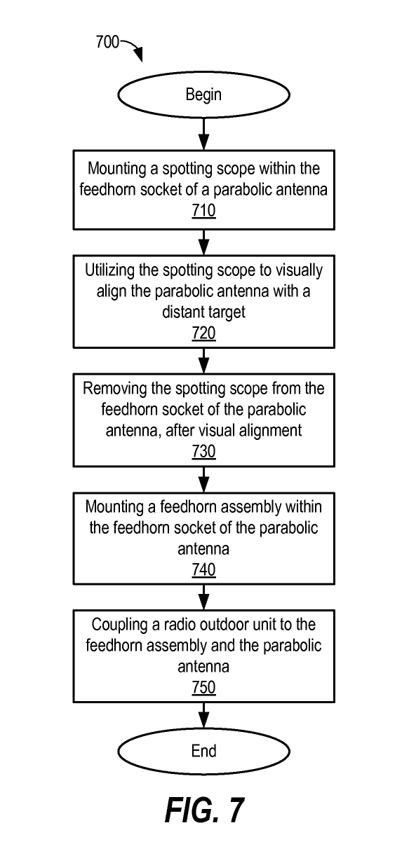

FIG. 7 illustrates a flow chart of an exemplary method 700 for visually aligning a parabolic antenna utilizing a spotting scope. As shown in FIG. 7, method 700 may include mounting 710 a spotting scope within the feedhorn socket of a parabolic antenna. Method 700 may further include a user utilizing 720 the spotting scope to visually (optically) align the parabolic antenna with respect to a distant target. The distant target may be a receiving antenna mounted on a separate building adjacent to the transmitting antenna, or it may be many kilometers away and located on a tall object such as a mountain-top according to two of the limitless configurations that may employ the various embodiments described herein. According to various embodiments, the radome of the parabolic antenna may include an optically transparent window coaxially positioned with respect to the mounted spotting scope allowing the user to see through the radome. The optically transparent window may be optically transparent window 120 as described herein and shown in FIG. 1. According to various alternative embodiments, the radome may be removed during the alignment process, and thus not require an optically transparent window. However, according to still other embodiments, removing the radome may not be feasible due to mechanical limitations, weight, inconvenience, and/or other factors.

Method 700 may further include removing 730 the spotting scope from the feedhorn socket of the parabolic antenna, once the parabolic antenna has been visually aligned to its target. Method 700 may further include mounting 740 a feedhorn assembly within the feedhorn socket of the parabolic antenna. According to one embodiment of step 740, a feedhorn assembly, may be optionally tuned to a specific frequency range, prior to mounting in the feedhorn socket. Method 700 may further include coupling 750 a radio outdoor unit to the feedhorn assembly and to the parabolic antenna. According to one embodiment of step 750, the radio outdoor may be mechanically secured to the concave side of the parabolic dish (see, e.g., concave side 634 and parabolic dish 630, FIG. 6 and related discussion above). According to still another embodiment of method 700, the radio outdoor unit may be coupled to the feedhorn assembly, but not physically mounted to the concave side of the parabolic dish.

According to the method 700 described above, a parabolic antenna may be optically aligned with respect to a distant target (another antenna) much quicker than with conventional methods. According to some embodiments, the visual alignment may be sufficiently accurate so as not to require further alignment. According to other embodiments, following the visual/optical alignment, relatively minor adjustments to the alignment may be made to ensure the best possible signal strength of transmitted and/or received signals.

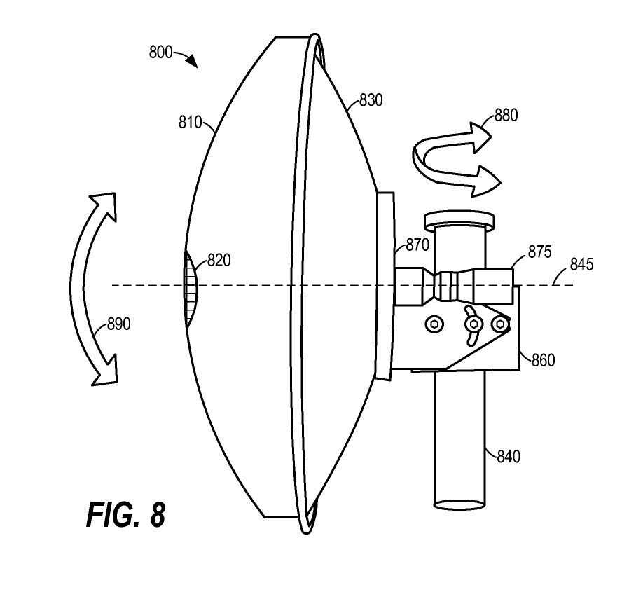

FIG. 8 illustrates an exemplary parabolic antenna 800 including a radome 810 with an optically transparent window 820 positioned coaxially (shown as dashed line 845) with respect to a spotting scope 875. The spotting scope 875 is shown mounted in a feedhorn socket (not visible in FIG. 8, but see, e.g., feedhorn socket 652 in FIG. 6) near the rear 870 of the parabolic dish 830. According to various embodiments, optically transparent window 820 may be any shape, size, and/or material as is deemed useful for a particular application or manufacturing process, subject to being optically transparent, i.e., distant objects may be viewed through the optically transparent window 820.

As illustrated, spotting scope 875 may be used to align parabolic antenna 800 with respect to a distant target (not show in FIG. 8). Rotating hardware 860 may allow parabolic antenna 800 to be rotated in the horizontal plane as illustrated by double headed-arrow 880), e.g., rotated about an axis of the mast 840. Rotating hardware 860 may also allow the parabolic antenna 800 to be pivoted in the vertical plane with respect to mast 840, as illustrated by the double-headed arrow 890 in FIG. 8. According to various alternative embodiments, rotational hardware and/or mast 840 may be replaced with any of a wide variety of mounting apparatuses known in the art that allow parabolic antenna 800 to be precisely aligned with respect to a distant target (another antenna) and subsequently secured in place for use in radio link communications.

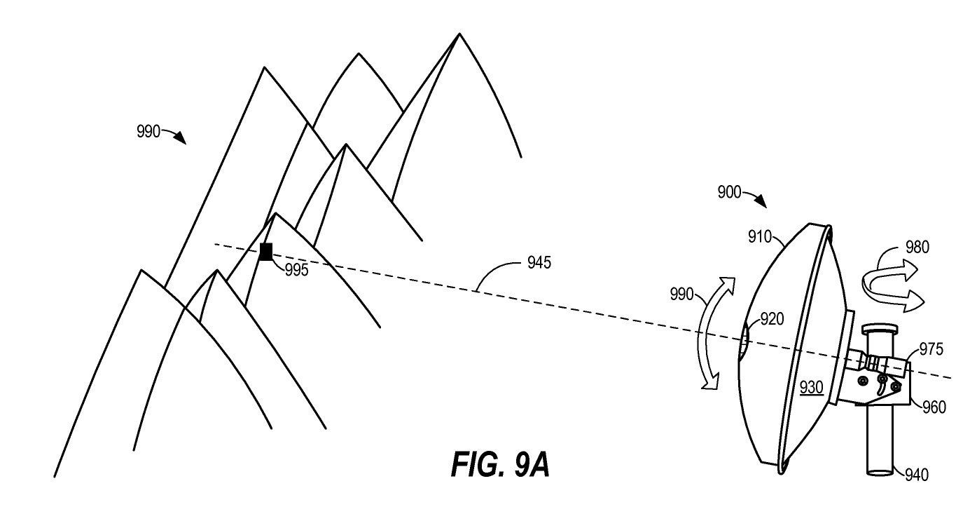

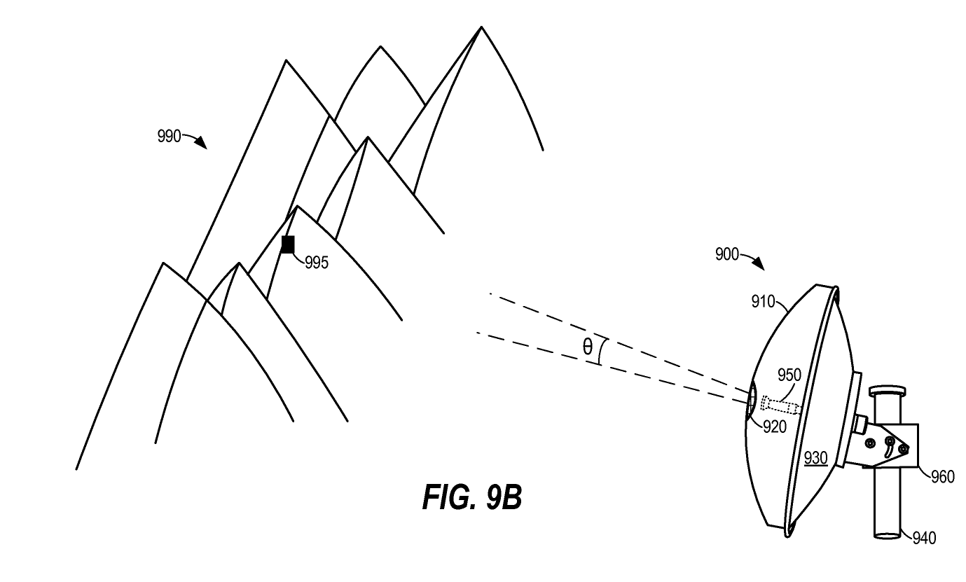

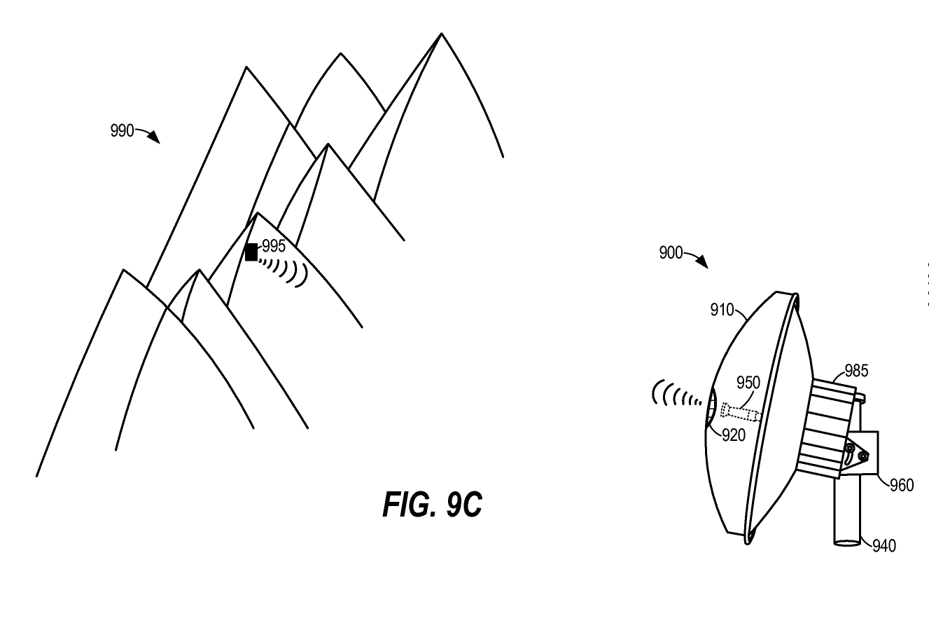

FIG. 9A is a diagram of an exemplary parabolic antenna 900 being optically aligned, illustrated as dashed line 945, with respect to a distant target 995 located on hills, shown at generally at arrow 990. According to various embodiments of parabolic antenna 900, radome 910 may include an optically transparent window 920 positioned coaxially (shown as dashed line 945) with respect to a spotting scope 975 mounted within a feedhorn socket near the rear of parabolic dish 930. As previously described, using rotating hardware 960, a user may horizontally rotate 980 or vertically pivot 990 the parabolic antenna 900 with respect to a mast 940 or other support structure to which the parabolic antenna may be mounted. Accordingly, parabolic antenna 900 may be visually aligned with respect to a distant target 995, e.g., another antenna, located on hills 990. According to various embodiments, a user may utilize one or more spotting scopes 975 having varying magnification properties in order to ensure accurate alignment. Alternatively, a spotting scope 975 may include zoom capabilities for rapidly changing magnification, or a finder scope providing less magnification, according to various embodiments. As is common in the art, spotting scopes 975 may include internal visual alignment markings, such as cross hairs, to facilitate a user's visual alignment of parabolic antenna 900 with respect to distant target 995.

According to other embodiments, spotting scope 975 may further include a laser or other signal light configured to facilitate the alignment process. For example, distant target 995 may comprise a parabolic antenna similar to parabolic antenna 900. Accordingly, a laser or signal light emitted from distant target 995 may facilitate a user aligning parabolic antenna 900. According to one embodiment, a laser or signal light may be configured to mount within the feedhorn socket along with the spotting scope 975.

As illustrated in FIG. 9B, once the parabolic antenna 900 has been aligned (dashed line 945 FIG. 9A) the spotting scope may be removed and a feedhorn assembly 950 (shown in dotted line) may be mounted within the feedhorn socket. According to various embodiments, radome 910 is configured to provide minimal or specifically tailored attenuation of radio signals while protecting feedhorn assembly 950 from the elements. As illustrated in FIG. 9B, feedhorn assembly 950 may be configured to provide a specific main lobe beam width θ. Beam width θ may selectively be relatively wide or very narrow to suit a particular application. For example, beam width θ may be only a few degrees or even a fraction of a degree, according to one embodiment. Accordingly, accurate alignment may be necessary in order to ensure sufficient signal strength for radio communication between parabolic antenna 900 and distant target 995. According to various embodiments, distant target 995 may be another parabolic antenna. Specifically, distant target 995 may be another parabolic antenna according to one of the embodiments described herein.

As illustrated in FIG. 9C, once feedhorn assembly 950 is placed within the feedhorn socket, an outdoor radio unit 985 maybe secured to parabolic antenna 900 coupled to the rear portion (hidden within unit 985, but see, e.g., rear portion 465 in FIG. 4B) of feedhorn assembly 950. Properly aligned, even with relatively narrow beam widths, parabolic antenna 900 may communicate with distant target 995 located on hills 990. According to various embodiments, communication may comprise transmitting and/or receiving radio signals. According to various embodiments, radio signals may be in any of a variety of frequency ranges, power intensities, and/or according to a variety of established or future communication protocols. According to various embodiments, the systems and methods for visual alignment described herein may be adapted for use with alternative antennas and future antennas as will be appreciated by one of skill in the art.

According to various embodiments, the spotting scope 375 (FIG. 3), 475 (FIG. 4A), 575 (FIG. 5), 875 (FIG. 8), 975 (FIG. 9A) may be machined such that the optical bore sight of the spotting scope 375 (FIG. 3), 475 (FIG. 4A), 575 (FIG. 5), 875 (FIG. 8), 975 (FIG. 9A) may be exactly in line with the radio frequency (RF) bore sight of the feedhorn assembly and parabolic antenna. According to various other embodiments, the spotting scope 375 (FIG. 3), 475 (FIG. 4A), 575 (FIG. 5), 875 (FIG. 8), 975 (FIG. 9A) may be configured to snap directly into feedhorn socket located at the back of the parabolic antenna in the exact same manner using the same methods as those used to secure the feedhorn assembly within the feedhorn socket to ensure spotting scopes and feedhorn assemblies are collinear. Tasco, Overland Park, Kans., is one of many manufacturers of riflescopes suitable for use as a spotting scope 375 (FIG. 3), 475 (FIG. 4A), 575 (FIG. 5), 875 (FIG. 8), 975 (FIG. 9A) described herein.

Spotting scopes may be calibrated in a test fixture to ensure that they are optically viewing the same location as the antenna radiates in the RF domain, i.e., they are calibrated during manufacturing such that optical alignment of a spotting scope ensures antenna alignment, according to one embodiment of the present invention. Thus, according to this embodiment, there is no need to calibrate the spotting scope once placed within the feedhorn socket, because the method of mounting the spotting scope to the parabolic antenna ensures calibration.

It will be understood that although various feedhorn assemblies 250 (FIG. 2), 550 (FIG. 5), 650 (FIG. 6) and 950 (FIGS. 9B-9C) have been illustrated, any suitable feedhorn assembly that may be placed within a feedhorn socket of a parabolic antenna may be used according to various embodiments of the present invention. For example, and not by way of limitation, Wireless Beehive Manufacturing, Lake Point Utah, offers the “Optic Series Feedhorns™” line of feedhorn assemblies for use with the parabolic antennas described herein that may be selected to operate with various commercially available outdoor radio units (ODUs), e.g., Dragonwave™, SAF™ and REMEC™, and configured for various reflector diameters, e.g., 2′-4′, various ranges of transmission frequencies, e.g., 2-60 GHz or specific transmission frequencies, e.g., 11, 13, 18, 23 and 24 GHz, and various waveguide types, e.g., circular, rectangular and dual polarization (also known in the art as “dual pol connectorized”). These various aspects of feedhorn assemblies are well known to those of ordinary skill in the art and, thus, will not be further elaborated herein. It will also be understood that the embodiments described herein may be used with a variety of commercially available parabolic antennas and/or radio equipment, e.g., Motorola™ PTP800™; Trango™ GigaPLUS™, GigaPRO™ and ApexPLUS™; Bridgewave™, SAF™, Solectek™ LM™, XM™ and CM™ Series; Exalt™; Proxim Wireless Tsunami GX800™; Wavelab™; Cielo Networks™ and Dragonwave™.

Another method for visually aligning a parabolic antenna is disclosed. The method may include mounting a spotting scope in a feedhorn socket of a parabolic antenna. The method may further include utilizing the spotting scope to optically align the parabolic antenna with respect to a distant target. The method may further include removing the spotting scope from the feedhorn socket of the parabolic antenna. The method may further include mounting a feedhorn assembly in the feedhorn socket of the parabolic antenna. The method may further include coupling a radio unit to the feedhorn assembly. According to one embodiment of the method, the parabolic antenna comprises a radome including an optically transparent window positioned coaxially with respect to the mounted spotting scope. According to another embodiment of the method, the parabolic antenna may further include a parabolic dish housing the feedhorn socket and a radome selectively separable from the parabolic antenna allowing the spotting scope to be optically unobstructed.

Another embodiment of a parabolic antenna for radio frequency communications is disclosed. The parabolic antenna may include a parabolic dish. The parabolic antenna may further include a feedhorn socket coupled to the parabolic dish. The parabolic antenna may further include a radome coupled to the parabolic dish, the radome including an optically transparent window. The parabolic antenna may further include the feedhorn socket configured to selectively receive a spotting scope, such that the spotting scope is coaxially secured with respect to the optically transparent window in the radome. The parabolic antenna may further include the feedhorn socket further configured to selectively receive a feedhorn assembly. According to another embodiment, the parabolic antenna may further include a radio unit coupled to the feedhorn assembly, the radio unit configured for radio communication. According to one embodiment, the feedhorn socket may be adapted to receive feedhorn assemblies comprising transmission frequencies selected from within a range from 2 GHz to 60 GHz. According to yet another embodiment, the feedhorn socket may be adapted to receive feedhorn assemblies having various waveguide types, e.g., and not by way of limitation: circular, rectangular and dual polarization waveguide types. According to yet another embodiment, the spotting scope may be a riflescope including optical indicia for aiming at a target.

According to still another embodiment, the parabolic antenna according to claim 6, further include rotating hardware mechanically coupled to the parabolic dish and configured for attachment to support structure. The rotating hardware may be adapted for selectively rotating the parabolic antenna in a horizontal plane relative to the support structure. The rotating hardware may further be adapted for selectively pivoting the parabolic antenna in a vertical plane relative to the support structure. The rotating hardware may further be adapted for locking the parabolic antenna in a selected position once the antenna has been aimed, for example by using the spotting scope. According to one embodiment of the parabolic antenna, the support structure may be a mast. However, in other embodiments the support structure may be a building or RF radio tower.

Another embodiment of a parabolic antenna for radio frequency communications is disclosed. According to this embodiment, the parabolic antenna may include a parabolic dish including a feedhorn socket adapted for receiving a feedhorn assembly. The parabolic antenna may further include a radome adapted for selective coupling to the parabolic dish and covering the feedhorn assembly. The parabolic antenna may further include rotating hardware mechanically coupled to the parabolic dish and configured for attachment to support structure. The rotating hardware may further be adapted for selectively rotating the parabolic antenna in a horizontal plane relative to the support structure. The rotating hardware may further be adapted for selectively pivoting the parabolic antenna in a vertical plane relative to the support structure. Finally, the rotating hardware may further be adapted for locking the parabolic antenna in a selected position.

The embodiment of a parabolic antenna may further include a spotting scope adapted to fit within the feedhorn socket. The spotting scope may further include optical indicia for aiming at a target. The embodiment of a parabolic antenna may further include the feedhorn assembly having a transmission frequency falling within a range from 2 GHz to 60 GHz. According to one embodiment, the parabolic antenna may further include a band and clamp mechanism for selectively securing the radome to the parabolic dish. According to another embodiment, the radome may further include an optically transparent window coaxially positioned relative to an optical bore sight of the spotting scope when the radome is coupled to the parabolic dish and the spotting scope is mounted within the feedsocket.

An embodiment of a method for visually aligning a parabolic antenna is disclosed. The method may include providing a parabolic antenna. The parabolic antenna may include a feedhorn assembly. The parabolic antenna may further include a parabolic dish having a feedhorn socket adapted for receiving the feedhorn assembly. The parabolic antenna may further include a radome adapted for selective coupling to the parabolic dish and covering the feedhorn assembly. The parabolic antenna may further include rotating hardware mechanically coupled to the parabolic dish and configured for attachment to support structure. The rotating hardware may of course be adapted for selectively rotating the parabolic antenna in a horizontal plane relative to the support structure. The rotating hardware may further be adapted for selectively pivoting the parabolic antenna in a vertical plane relative to the support structure. The rotating hardware may further be adapted for locking the parabolic antenna in a selected position. The parabolic antenna may further include a spotting scope adapted to fit within the feedhorn socket and having optical indicia for aiming at a target. The method for visually aligning a parabolic antenna may further include mounting the spotting scope within the feedhorn socket of the parabolic antenna. The method may further include optically aligning the parabolic antenna with respect to a distant target using the spotting scope. The method may further include removing the spotting scope from the feedhorn socket of the parabolic antenna. The method may further include mounting the feedhorn assembly within the feedhorn socket of the parabolic antenna.

According to another embodiment, the method for visually aligning a parabolic antenna, may further include providing an outdoor radio unit. The method may further include coupling the outdoor radio unit to the feedhorn assembly. According to one embodiment of the method, optically aligning the parabolic antenna may include adjusting the rotating hardware by selectively rotating the parabolic antenna in a horizontal plane relative to the support structure. According to this embodiment, optically aligning the parabolic antenna may further include selectively pivoting the parabolic antenna in a vertical plane relative to the support structure. According to this embodiment, optically aligning the parabolic antenna may further include locking the parabolic antenna in a selected position. According to another embodiment, the radome may further include an optically transparent window positioned coaxially with respect to the spotting scope mounted within the feedhorn socket.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

What is claimed is:

1. A method for visually aligning a parabolic antenna comprising:
mounting a spotting scope in a feedhorn socket of a parabolic antenna;
utilizing the spotting scope to optically align the parabolic antenna with respect to a distant target; and
removing the spotting scope from the feedhorn socket of the parabolic antenna.

2. The method according to claim 1, further comprising mounting a feedhorn assembly in the feedhorn socket of the parabolic antenna.

3. The method according to claim 1, further comprising coupling a radio unit to the feedhorn assembly.

4. The method according to claim 1, wherein the parabolic antenna comprises a radome including an optically transparent window positioned coaxially with respect to the mounted spotting scope.

5. The method according to claim 1, wherein the parabolic antenna further comprises:
a parabolic dish housing the feedhorn socket; and
a radome selectively separable from the parabolic antenna allowing the spotting scope to be optically unobstructed.

6. A parabolic antenna for radio frequency communications, comprising:
a parabolic dish;
a feedhorn socket coupled to the parabolic dish;
a radome coupled to the parabolic dish, the radome including an optically transparent window;
the feedhorn socket configured to selectively receive a spotting scope, such that the spotting scope is coaxially secured with respect to the optically transparent window in the radome; and
the feedhorn socket further configured to selectively receive a feedhorn assembly.

7. The parabolic antenna of claim 6, wherein the parabolic antenna further comprises a radio unit coupled to the feedhorn assembly, the radio unit configured for radio communication.

8. The parabolic antenna according to claim 6, wherein the feedhorn socket is adapted to receive feedhorn assemblies comprising transmission frequencies selected from within a range from 2 GHz to 60 GHz.

9. The parabolic antenna according to claim 6, wherein the feedhorn socket is adapted to receive feedhorn assemblies comprising waveguide types selected from the group consisting of: circular, rectangular and dual polarization.

10. The parabolic antenna according to claim 6, wherein the spotting scope comprises a riflescope including optical indicia for aiming at a target.

11. The parabolic antenna according to claim 6, further comprising rotating hardware mechanically coupled to the parabolic dish and configured for attachment to support structure, the rotating hardware adapted for selectively rotating the parabolic antenna in a horizontal plane relative to the support structure and further adapted for selectively pivoting the parabolic antenna in a vertical plane relative to the support structure and further adapted for locking the parabolic antenna in a selected position.

12. The parabolic antenna according to claim 11, wherein the support structure is a mast.

13. A parabolic antenna for radio frequency communications, comprising:
a parabolic dish including a feedhorn socket adapted for receiving a feedhorn assembly;
a radome adapted for selective coupling to the parabolic dish and covering the feedhorn assembly;
rotating hardware mechanically coupled to the parabolic dish and configured for attachment to support structure, the rotating hardware adapted for selectively rotating the parabolic antenna in a horizontal plane relative to the support structure and further adapted for selectively pivoting the parabolic antenna in a vertical plane relative to the support structure and further adapted for locking the parabolic antenna in a selected position; and
a spotting scope adapted to fit within the feedhorn socket and having optical indicia for aiming at a target.

14. The parabolic antenna according to claim 13, wherein the feedhorn assembly comprises a transmission frequency falling within a range from 2 GHz to 60 GHz.

15. The parabolic antenna according to claim 13, wherein the radome further comprises a band and clamp mechanism for selectively securing the radome to the parabolic dish.

16. The parabolic antenna according to claim 13, wherein the radome further comprises an optically transparent window coaxially positioned relative to an optical boresight of the spotting scope when the radome is coupled to the parabolic dish and the spotting scope is mounted within the feedsocket.

17. A method for visually aligning a parabolic antenna comprising:
providing a parabolic antenna, comprising:
a feedhorn assembly;
a parabolic dish including a feedhorn socket adapted for receiving the feedhorn assembly;
a radome adapted for selective coupling to the parabolic dish and covering the feedhorn assembly;
rotating hardware mechanically coupled to the parabolic dish and configured for attachment to support structure, the rotating hardware adapted for selectively rotating the parabolic antenna in a horizontal plane relative to the support structure and further adapted for selectively pivoting the parabolic antenna in a vertical plane relative to the support structure and further adapted for locking the parabolic antenna in a selected position; and
a spotting scope adapted to fit within the feedhorn socket and having optical indicia for aiming at a target;
mounting the spotting scope within the feedhorn socket of the parabolic antenna;
optically aligning the parabolic antenna with respect to a distant target using the spotting scope;
removing the spotting scope from the feedhorn socket of the parabolic antenna; and
mounting the feedhorn assembly within the feedhorn socket of the parabolic antenna.

18. The method according to claim 17, further comprising;
providing an outdoor radio unit; and
coupling the outdoor radio unit to the feedhorn assembly.

19. The method according to claim 17, wherein optically aligning the parabolic antenna comprises adjusting the rotating hardware by:
selectively rotating the parabolic antenna in a horizontal plane relative to the support structure;
selectively pivoting the parabolic antenna in a vertical plane relative to the support structure; and
locking the parabolic antenna in a selected position.

20. The method according to claim 17, wherein the radome further comprises an optically transparent window positioned coaxially with respect to the spotting scope mounted within the feedhorn socket.
